(19) United States
(12) Patent Application Publication
(10) Pub. No.: US 2026/0186490 A1
(43) Pub. Date: Jul. 2, 2026

(54) Method of Controlling Automated Guided Vehicle, Automated Guided Vehicle and Systems

(71) Applicant: ABB Schweiz AG, Baden (CH)

(72) Inventor: Jonas Larsson, Västerås (SE)

(73) Assignee: ABB Schweiz AG, Baden (CH)

(21) Appl. No.: 19/546,768

(22) Filed: Feb. 23, 2026

Related U.S. Application Data
(63) Continuation of application No. PCT/EP2023/074131, filed on Sep. 4, 2023.

(51) Int. Cl. G05D 1/229; G05D 1/224; G05D 109/18

(52) U.S. Cl. CPC G05D 1/2297; G05D 1/2244; G05D 2109/18

(57) ABSTRACT

A method of controlling an automated guided vehicle (AGV) includes at least one drive wheel connected to the base and being rotatable relative to the base around a drive axis to generate a tractive force in a heading direction transverse to the drive axis; and a control system that controls the AGV, selects a compliance direction in which the base should exhibit a compliant behavior, and includes an AGV control program, the AGV control program comprising program code which, when executed by the control system, causes the control system to control the AGV to be positioned at standstill such that the heading direction of each drive wheel is aligned with the compliance direction; and executing, by the control system, the AGV control program.

### CROSS-REFERENCE TO RELATED APPLICATIONS

The instant application claims priority to International Patent Application No. PCT/EP2023/074131, filed September 4, 2023, which is incorporated herein in its entirety by reference.

### FIELD OF THE DISCLOSURE

The present disclosure generally relates to automated guided vehicles (AGVs) and, more particularly, to a method of controlling an AGV, an AGV, and systems comprising an AGV.

### BACKGROUND OF THE INVENTION

Automated guided vehicles, AGVs, are typically self-powered, self-driven vehicles used to transport materials and other items from one location to another, without the need for a driver on the vehicle. AGVs are commonly used in manufacturing sites, warehouses, post offices, libraries, port terminals, airports, and some hazardous locations and specialty industries. In some applications where an AGV is at standstill at a workplace, it is beneficial if a human user can temporarily move the AGV aside to make space if needed.

JP 2011232815 A discloses a mobile robot comprising an upper body, a moving part and differential drive wheels. A force sensor is used to detect an external force vector applied to the upper body. A mechanical impedance can be set based on the external force vector. In this way, a person can push the mobile robot by hand in order to move the mobile robot.

The principle described in JP 2011232815 A requires continuous knowledge of the external force vector to set the mechanical impedance and is thus a reactive control principle. Moreover, when the person tries to push the mobile robot, the mobile robot first has to detect the external force vector applied, then align the drive wheels with the external force vector and then set the mechanical impedance of the drive wheels. Thus, unless the person pushes (or pulls) the mobile robot in the heading direction of the drive wheels, it will take long time before the mobile robot is made compliant in the direction of pushing (or pulling). During this time, the person may conclude that it is not possible to manually move the mobile robot and stop pushing the same.

### BRIEF SUMMARY OF THE INVENTION

In one aspect, the present disclosure describes an improved method of controlling an automated guided vehicle, AGV. In other aspects, the disclosure describes an improved AGV, an improved system comprising an AGV and a programming device, and an improved system comprising an AGV and a display device.

By selecting a compliance direction in which a base of an AGV should be made compliant, and by providing an AGV control program taking this selected compliance direction into account by controlling the AGV to be positioned at standstill with a heading direction of each drive wheel of the AGV aligned with the compliance direction, a proactive, rather than a reactive, compliance is provided which improves safety and user experience.

According to a first aspect, there is provided a method of controlling an automated guided vehicle, AGV, the AGV comprising a base; at least one drive wheel connected to the base, each drive wheel being rotatable relative to the base around a drive axis to generate a tractive force in a heading direction transverse to the drive axis; and a control system configured to control the AGV; wherein the method comprises selecting a compliance direction in which the base should exhibit a compliant behavior; providing, in the control system and based on the selected compliance direction, an AGV control program, the AGV control program comprising program code which, when executed by the control system, causes the control system to control the AGV to be positioned at standstill such that the heading direction of each drive wheel is aligned with the compliance direction and such that the base exhibits the compliant behavior in the compliance direction; and executing, by the control system, the AGV control program.

### BRIEF DESCRIPTION OF THE SEVERAL VIEWS OF THE DRAWING(S)

FIG. 1 is a diagram of a side view of a system comprising an AGV and a programming device, in accordance with the disclosure.

FIG. 2 is a diagram of a cross-sectional side view of a drive unit of the AGV of FIG. 1.

FIG. 3 is a diagram of a top view of the AGV at standstill, a compliance direction and a visual indication, in accordance with the disclosure.

FIG. 4 is a diagram of a further top view of the AGV at standstill, in accordance with the disclosure.

FIG. 5 is diagram of a top view of the AGV and a further example of a compliance direction, in accordance with the disclosure.

FIG. 6 is a diagram of a top view of the AGV and a further example of a compliance direction, in accordance with the disclosure.

FIG. 7 is a diagram of a top view of the AGV and a further example of a compliance direction, in accordance with the disclosure.

FIG. 8a is view of a user interface of the programming device and examples of coordinate system selection inputs, in accordance with the disclosure.

FIG. 8b is a view of a user interface of the programming device and examples of direction selection inputs, in accordance with the disclosure.

FIG. 8c is a view of a user interface of the programming device and further examples of direction selection inputs, in accordance with the disclosure.

FIG. 8d is a view of a user interface of the programming device and further examples of direction selection inputs, in accordance with the disclosure.

FIG. 8e is a view of a user interface of the programming device and one example of an impedance selection input, in accordance with the disclosure.

FIG. 8f is a view of a user interface of the programming device and examples of control type inputs, in accordance with the disclosure.

FIG. 9 is a diagram of a cross-sectional side view of a further example of a drive unit for the AGV, in accordance with the disclosure.

FIG. 10 is a diagram of a top view of an AGV according to a further example comprising the drive unit in FIG. 9.

FIG. 11 is a diagram of a top view of an AGV according to a further example comprising the drive unit in FIG. 2.

FIG. 12 is a flowchart outlining general steps of a method, in accordance with the disclosure.

### DETAILED DESCRIPTION OF THE INVENTION

In the following, a method of controlling an AGV, an AGV, and a system comprising an AGV, will be described. The same or similar reference numerals will be used to denote the same or similar structural features.

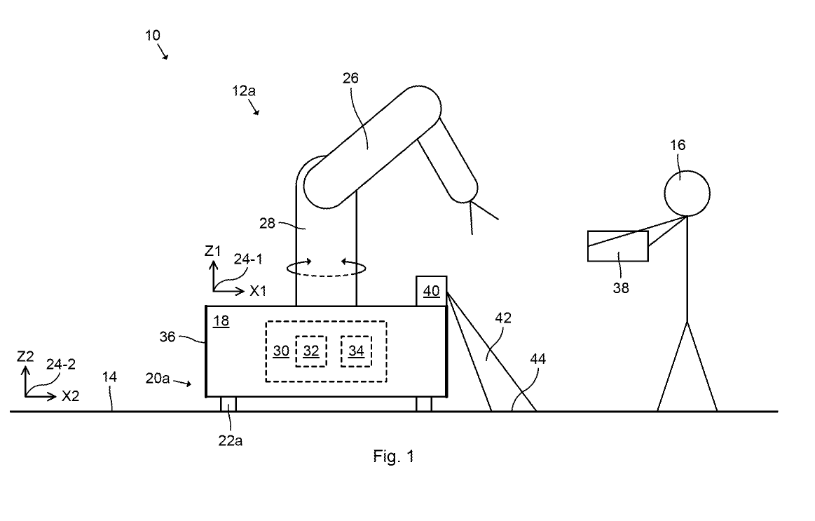

FIG. 1 schematically represents a side view of a system 10. The system 10 comprises an automated guided vehicle 12a, AGV. The system 10 may thus be referred to as an AGV system. In FIG. 1, the AGV 12a is positioned on a horizontal ground surface 14, here exemplified as a floor. FIG. 1 further shows a human user 16 next to the AGV 12a.

The AGV 12a comprises a base 18, here exemplified as a platform. The AGV 12a of this example further comprises a traction arrangement 20a. The traction arrangement 20a of this example comprises a plurality of drive wheels 22a, here four drive wheels 22a (only two are visible in FIG. 1). Each drive wheel 22a is connected to the base 18. The AGV 12a may further comprise a power source (not shown), such as a battery, to power the drive wheels 22a.

FIG. 1 further shows a local coordinate system 24-1 and a global coordinate system 24-2. In this example, the local coordinate system 24-1 is fixed with respect to the base 18 and the global coordinate system 24-2 is fixed with respect to the ground surface 14.

The AGV 12a of this example further comprises a manipulator 26, here exemplified as a serial robot arm programmable in at least three axes. The manipulator 26 is supported on the base 18 and is movable relative to the base 18. The manipulator 26 of this example comprises plurality of links, including a first link 28. The first link 28 is rotatable relative to the base 18 around a vertical axis as shown with a corresponding arrow. The first link 28 is one example of a body according to the present disclosure. The manipulator 26 of this example is a compliant manipulator, e.g., comprising motors with a limited power so as not being capable of injuring humans.

The AGV 12a further comprises an electronic control system 30 configured to control the AGV 12a. The control system 30 of this example comprises a data processing device 32 and a memory 34. The memory 34 has a computer program stored therein. The computer program comprises program code which, when executed by the data processing device 32, causes the data processing device 32 to perform, or command performance of, various steps as described herein. An AGV control program is also stored in the memory 34. When the AGV control program is executed, the AGV 12a is controlled to perform various tasks.

The base 18 of this example comprises a skirt 36. As shown in FIG. 1, the skirt 36 partly covers the drive wheels 22a. Thus, the user 16 may therefore not see the respective orientations of the drive wheels 22a.

The system 10 of this example further comprises a programming device 38, here exemplified as a teach pendant unit, TPU. The user 16 may create and/or modify the AGV control program using the programming device 38. In this example, the programming device 38 is configured to wirelessly communicate with the control system 30.

The system 10 of this example further comprises a projector 40. The projector 40 is one example of a display device according to the present disclosure. The projector 40 is fixed to the base 18 in this example but may alternatively be positioned elsewhere, such as at a stationary position in the global coordinate system 24-2. The projector 40 is in signal communication with the control system 30. As shown in FIG. 1, the projector 40 is configured to project a light beam 42 to provide a visual indication 44, i.e., a projection in this example. The visual indication 44 is projected by the projector 40 on the ground surface 14. The visual indication 44 may however alternatively be provided elsewhere in the environment of the AGV 12a, such as on the base 18.

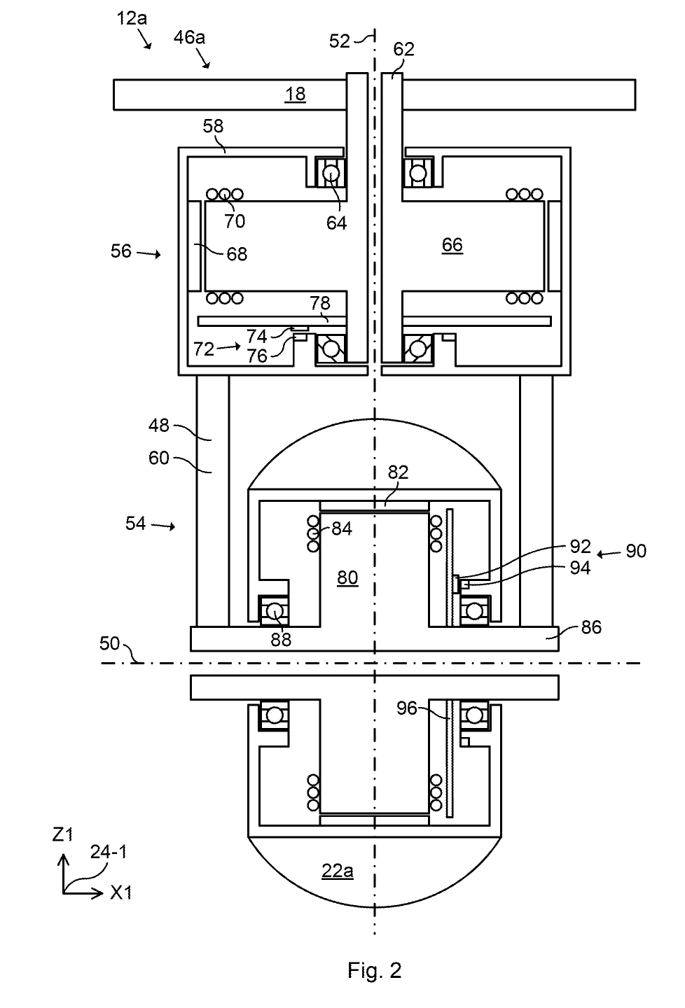

FIG. 2 schematically represents a cross-sectional view of one specific example of a drive unit 46a for the AGV 12a. The AGV 12a is only partially illustrated in FIG. 2. Each drive unit 46a comprises a drive wheel 22a and is connected to the base 18. The AGV 12a of this specific and non-limiting example comprises four drive units 46a of the same design.

The drive unit 46a of this specific and non-limiting example further comprises a driven steering member 48. The drive wheel 22a is rotatable around a drive axis 50 to generate a tractive force in a heading direction transverse to the drive axis 50. The driven steering member 48 and the drive wheel 22a are rotatable around a steering axis 52. The drive axis 50 is perpendicular to the steering axis 52. Moreover, the drive axis 50 intersects the steering axis 52. In FIG. 2, the drive axis 50 is horizontal and the steering axis 52 is vertical. The drive axis 50 provides a first degree of freedom for the drive unit 46a. The steering axis 52 provides a second degree of freedom for the drive unit 46a.

The drive unit 46a, further comprises an electric synchronous wheel motor 54. The wheel motor 54 is arranged to rotationally drive the drive wheel 22a around the drive axis 50. In this example, the wheel motor 54 is arranged to directly drive the drive wheel 22a, i.e., without any intermediate gearing between the wheel motor 54 and the drive wheel 22a.

The drive unit 46a further comprises an electric synchronous steering motor 56. The steering motor 56 is arranged to rotationally drive the driven steering member 48 around the steering axis 52. The steering motor 56 and the wheel motor 54 may for example each provide a torque of at least 5 Nm. The drive wheel 22a is thus a steerable drive wheel. Since the AGV 12a of this example comprises four drive wheels 22a, the AGV 12a can perform an omnidirectional motion of the base 18.

The steering motor 56 is arranged to directly drive the driven steering member 48, i.e., without any intermediate gearing between the steering motor 56 and the driven steering member 48. The driven steering member 48 of the example in FIG. 2 comprises a base part 58 and two arm parts 60 extending downwards from the base part 58.

The drive unit 46a further comprises a steering shaft 62 and two steering bearings 64 for rotationally supporting the driven steering member 48 around the steering axis 52. The steering shaft 62 is rigidly connected to the base 18 of the AGV 12a. The steering motor 56 comprises a steering stator 66, a steering rotor 68 and steering coils 70. The steering rotor 68 is arranged inside the base part 58. The steering coils 70 are arranged on the steering stator 66. In this example, the base part 58 is an integral part of the steering rotor 68.

The drive unit 46a further comprises a steering sensor device 72. The steering sensor device 72 determines a rotational position of the driven steering member 48, and consequently also of the drive wheel 22a, around the steering axis 52. The steering sensor device 72 is in signal communication with the control system 30. The steering sensor device 72 of this example comprises an active part, here constituted by a Hall effect steering sensor 74, and a passive part, here constituted by a multipole steering encoder ring 76.

The drive unit 46a further comprises a steering circuit board 78. The Hall effect steering sensor 74 is provided on the steering circuit board 78. The steering encoder ring 76 is connected to the driven steering member 48.

The wheel motor 54 comprises a wheel stator 80, a wheel rotor 82 and wheel coils 84. The wheel stator 80 is arranged inside the drive wheel 22a. The wheel coils 84 are arranged on the wheel stator 80. The drive unit 46a further comprises a wheel shaft 86 and two wheel bearings 88 for rotationally supporting the drive wheel 22a around the drive axis 50. The wheel shaft 86 is rigidly connected to the arm parts 60 of the driven steering member 48.

The drive unit 46a further comprises a wheel sensor device 90. The wheel sensor device 90 may be of the same type as the steering sensor device 72. The wheel sensor device 90 determines a rotational position of the drive wheel 22a around the drive axis 50. The wheel sensor device 90 is in signal communication with the control system 30. The wheel sensor device 90 of this example comprises an active part, here constituted by a Hall effect wheel sensor 92, and a passive part, here constituted by a multipole wheel encoder ring 94.

The drive unit 46a further comprises a wheel circuit board 96. The Hall effect wheel sensor 92 is provided on the wheel circuit board 96. The wheel encoder ring 94 is connected to the drive wheel 22a.

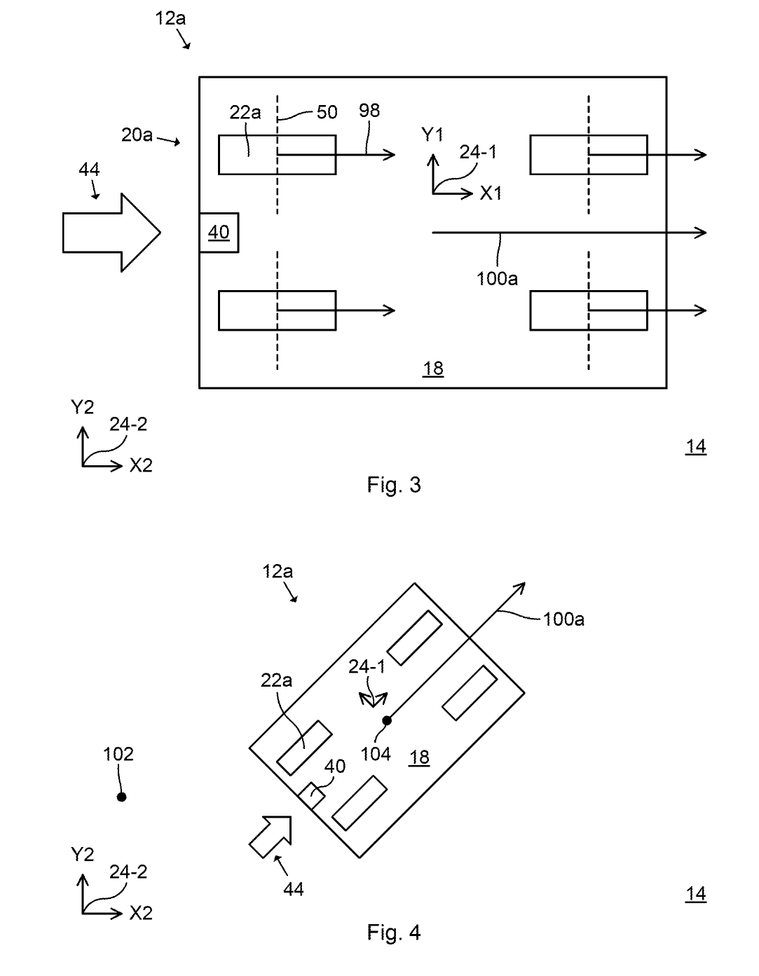

FIG. 3 schematically represents a top view of the AGV 12a with the manipulator 26 omitted. In FIG. 3, the AGV 12a is at standstill and a heading direction 98 of each drive wheel 22a is aligned with a selected compliance direction 100a such that the base 18 exhibits a compliant behavior in the compliance direction 100a. The user 16 can thereby push the base 18 to move the AGV 12a along the ground surface 14 and away from the stationary position. The compliance direction 100a is a direction in which the AGV 12a is compliant when the user 16 pushes or pulls the AGV 12a. The manipulator 26 may move relative to the base 18 to perform a task when the AGV 12a is at standstill.

The compliance direction 100a may be selected by the user 16 or by the control system 30. In any case, the AGV control program is provided by the control system 30, e.g., created or updated, based on the selected compliance direction 100a. The compliance direction 100a may be selected arbitrarily in the horizontal plane.

In this example, each drive wheel 22a is position controlled by the control system 30. Each drive wheel 22a thereby made compliant in the heading direction 98. When each drive wheel 22a is positioned controlled, a position control loop may be used where a measured drive wheel position of each drive wheel 22a, e.g., as determined based on signals from the respective wheel sensor devices 90, is fed back and compared with a respective target drive wheel position. A gain of the position control loop may for example be changed to adjust the compliance of the drive wheel 22a in the heading direction 98. When the gain is set to a relatively low value, the compliance is relatively high. Conversely, when the gain is set to a relatively high value, higher than the relatively low value, the compliance is relatively small, i.e., smaller than the relatively high compliance. The gain may for example also be increased in proportion to an increase of an error between the measured drive wheel position and the target drive wheel position. In this way, the base 18 will exhibit a progressively increasing resistance against manual forcing by the user 16 in the compliance direction 100a away from the standstill position.

With position control, the base 18 will act as a spring when pushed away from a target position and will return to the target position when the push is released. Any operation carried out by the manipulator 26 may be stopped once the AGV 12a detects deviation of the base 18 from a target position, e.g., based on signals from the respective wheel sensor devices 90. Once the AGV 12a returns to the target position, the manipulator 26 may resume its operation.

As an alternative, each drive wheel 22a may be velocity controlled. In this case, a velocity control loop may be used where a measured drive wheel velocity of each drive wheel 22a, e.g., as determined based on signals from the wheel sensor devices 90, is fed back and compared with a respective target drive wheel velocity, which may be set to zero at standstill. A gain of the velocity control loop may for example be changed to adjust the compliance of the drive wheel 22a in the heading direction 98.

Position control loops and velocity control loops as mentioned above are as such well known to a person skilled in the art. Each drive wheel 22a may be controlled such that a force of at least 30 N acting on the base 18 in the compliance direction 100a will cause the base 18 to move.

In case the AGV 12a is occupying a workplace and the user 16 needs to swiftly pick up an item on the ground surface 14 underneath the AGV 12a, the user 16 may simply push the AGV 12a aside in the compliance direction 100a, pick up the item and then stop pushing the AGV 12a. When the drive wheels 22a are position controlled, the AGV 12a will return to its original position when the user 16 stops pushing the AGV 12a.

If the manipulator 26 would instead be attached to a stationary structure and adopt a position close to singularity, its inherent compliant behavior may be reduced, considering for example that a fully extended manipulator 26 may lose its ability to be compliant in the direction of extension. However, when the manipulator 26 attached to the base 18 is pushed in the compliance direction 100a, the compliant behavior exhibited by the AGV 12a by aligning the heading direction 98 of each drive wheel 22a with the compliance direction 100a can be used to provide compliance also to the manipulator 26 when close to singularity.

FIG. 3 further shows one example of the visual indication 44. The visual indication 44 is here exemplified as an arrow in the compliance direction 100a projected on the ground surface 14 and is thus indicative of the compliance direction 100a. The control system 30 is configured to control the projector 40 to provide the visual indication 44 corresponding to the selected compliance direction 100a.

FIG. 4 schematically represents a top view of the AGV 12a. In FIG. 4, the AGV 12a is at standstill in a position different from FIG. 3. In FIG. 3, the AGV 12a has moved, by driving the drive wheels 22a, in the global coordinate system 24-2 along a path from a start position 102 to a target position 104 under the control of the AGV control program. A distance between the start position 102 and the target position 104 may be at least one meter. When the AGV 12a has come to standstill at the target position 104, the drive wheel 22a are controlled to be oriented such that the heading directions 98 are aligned with the compliance direction 100a.

In this example, the compliance direction 100a is defined in the local coordinate system 24-1. Thus, regardless of the orientation adopted by the base 18 in the global coordinate system 24-2, the compliance direction 100a is the same in the local coordinate system 24-1 when the AGV 12a has come to standstill at the target position 104.

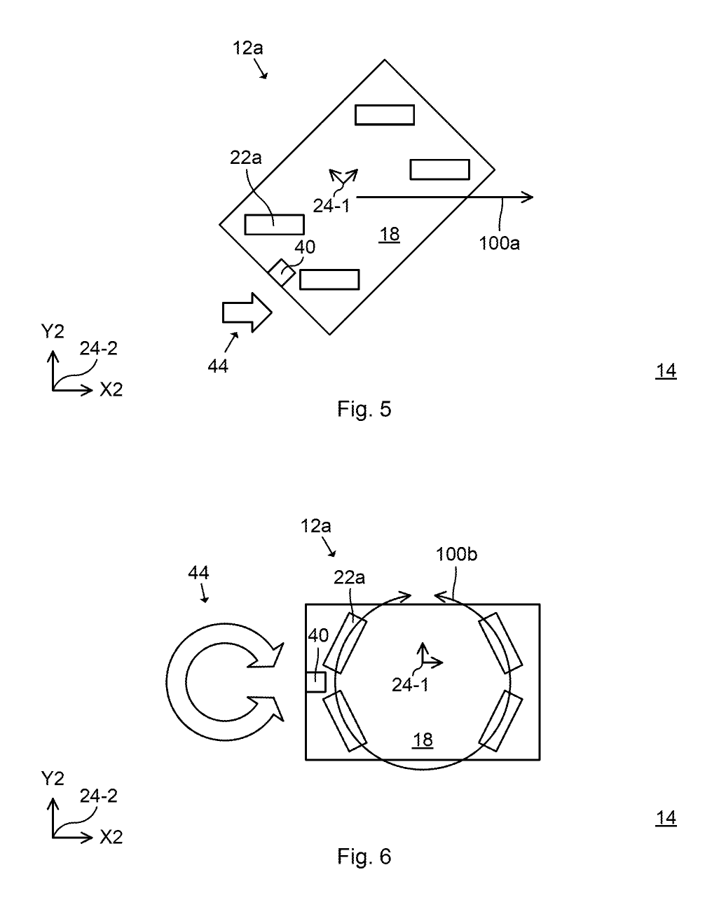

FIG. 5 schematically represents a top view of the AGV 12a and a further example of a compliance direction 100a. In FIG. 5, the compliance direction 100a is defined in the global coordinate system 24-2. Thus, regardless of the orientation adopted by the base 18 in the global coordinate system 24-2, compliance direction 100a is the same in the global coordinate system 24-2 when the AGV 12a has come to standstill at a target position 104.

FIG. 6 schematically represents a top view of the AGV 12a and a further example of a compliance direction 100b. The compliance direction 100b of this example is a circle. As shown, each drive wheel 22a is here oriented such that the heading directions 98 are aligned with the circle of the compliance direction 100b. Each heading direction 98 is thus oriented transverse to a line between a center of the circle and the respective drive wheel 22a.

The visual indication 44 is now projected as a corresponding circle to indicate to the user 16 that the compliance direction 100b is circular. One or both compliance directions 100a and 100b may also be referred to with reference numeral "100".

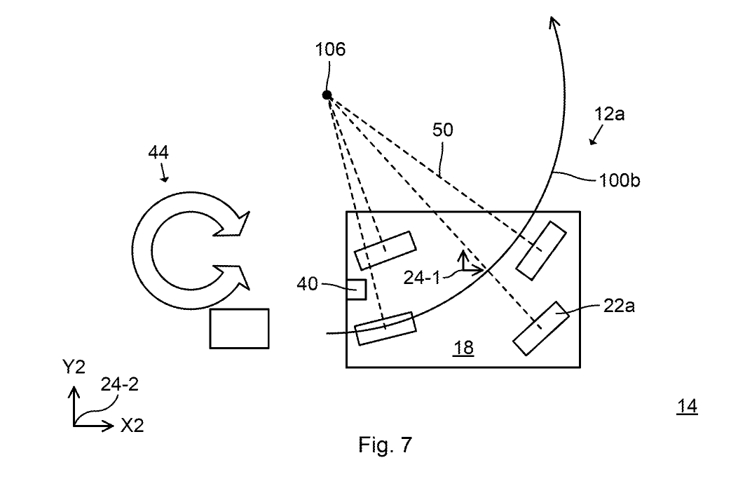

FIG. 7 schematically represents a top view of the AGV 12a and a further example of a compliance direction 100b. In FIG. 7, the compliance direction 100b is circular and centered outside the base 18. As shown, each drive wheel 22a is here oriented such that an instantaneous center of rotation 106, ICR, of the drive wheels 22a is centered in the circle of the compliance direction 100b. That is, the drive axes 50 of all drive wheels 22a coincides at the ICR 106. Also in this way, the base 18 exhibits the compliant behavior in the compliance direction 100b. The visual indication 44 of this example is now projected as a box and a circle, where the box represents the base 18 and the circle represents the compliance direction 100b and its relation to the base 18.

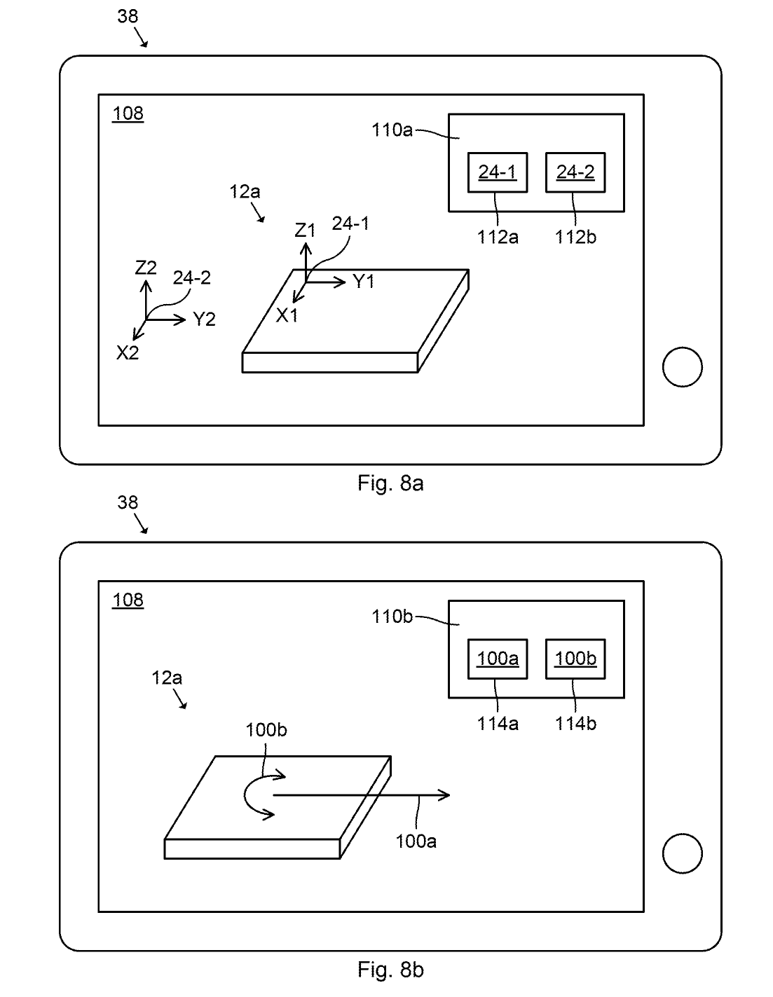

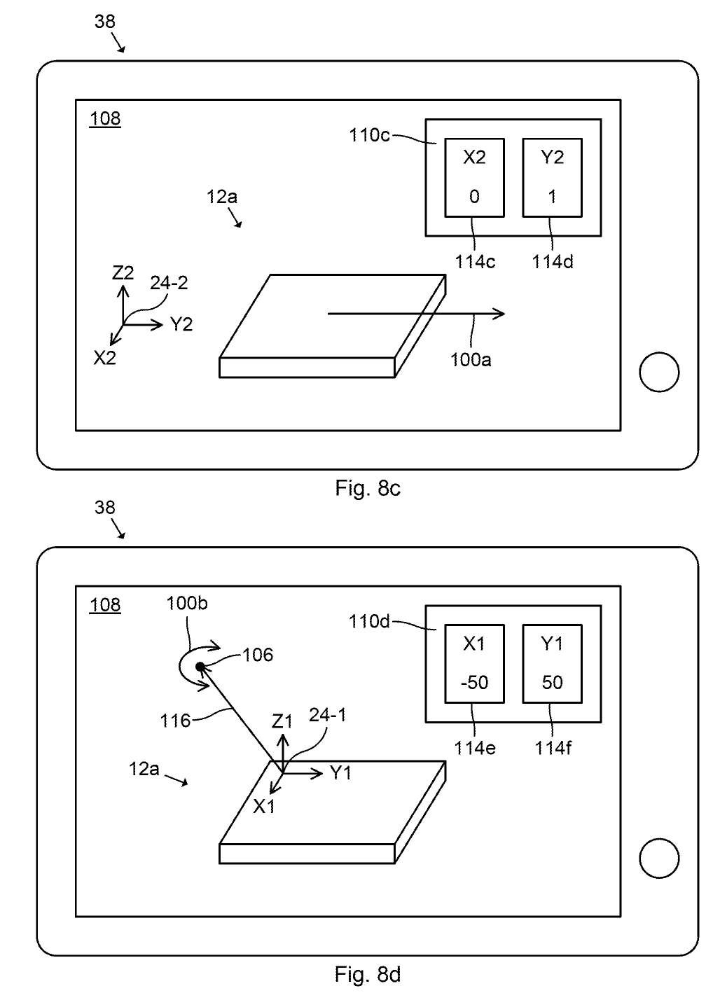

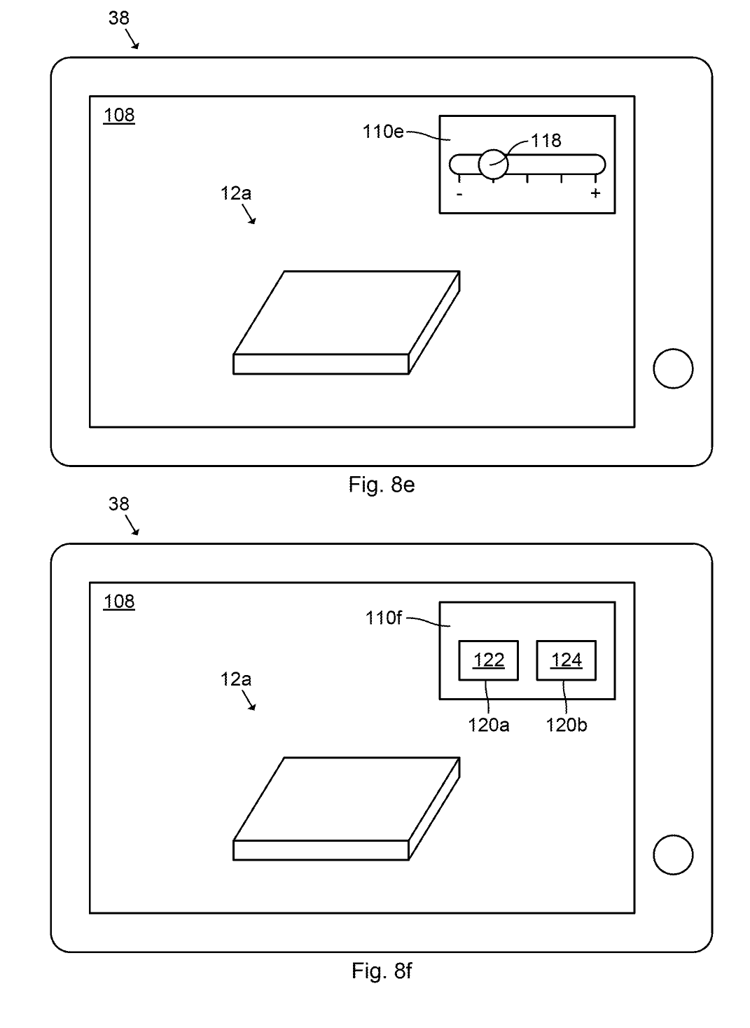

FIG. 8a schematically represents the programming device 38. The programming device 38 of this example comprises a display 108. The programming device 38 in configured to provide various user interfaces on the display 108 through which the user 16 may set the compliance direction 100 and various properties thereof.

In FIG. 8a, the programming device 38 shows a dialog box 110a on the display 108 to which the user 16 can provide a selection as to whether the compliance direction 100 should be defined in the local coordinate system 24-1 or in the global coordinate system 24-2. The user 16 may provide a first coordinate system selection input 112a to select the local coordinate system 24-1 and a second coordinate system selection input 112b to select the global coordinate system 24-2.

FIG. 8b schematically represents the programming device 38 when a further example of a dialog box 110b is shown on the display 108 to which the user 16 can provide a selection as to whether the compliance direction should be a linear compliance direction 100a or a circular compliance direction 100b. The user 16 may provide a first direction selection input 114a to select a linear compliance direction 100a and second direction selection input 114b to select a circular compliance direction 100b.

FIG. 8c schematically represents the programming device 38 when a further example of a dialog box 110c is shown on the display 108. In FIG. 8c, it is assumed that the user 16 has selected a linear compliance direction 100a and that this compliance direction 100a should be defined in the global coordinate system 24-2. In response to the dialog box 110c, the user 16 may provide a third direction selection input 114c and a fourth direction selection input 114d to define a direction of the compliance direction 100a in the global coordinate system 24-2. In this example, the third direction selection input 114c is a value in the X2-direction of the global coordinate system 24-2 and the fourth direction selection input 114d is a value in the Y2-direction of the global coordinate system 24-2. As illustrated, by entering a value "0" as the third direction selection input 114c and a value "1" as the fourth direction selection input 114d, it can be defined that the compliance direction 100a should be parallel with the Y2-direction.

FIG. 8d schematically represents the programming device 38 when a further example of a dialog box 110d is shown on the display 108. In FIG. 8d, it is assumed that the user 16 has selected a circular compliance direction 100b and that this compliance direction 100b should be defined in the local coordinate system 24-1. In response to the dialog box 110d, the user 16 may provide a fifth direction selection input 114e and a sixth direction selection input 114f to define a position of the circle of the compliance direction 100b in the local coordinate system 24-1, which will here also be the ICR 106. In this example, the fifth direction selection input 114e is a value in the X1-direction of the local coordinate system 24-1 and the sixth direction selection input 114f is a value in the Y1-direction of the local coordinate system 24-1. As illustrated, by entering a value "-50" as the fifth direction selection input 114e and a value "50" as the sixth direction selection input 114f, the position of the ICR 106 in the local coordinate system 24-1 is defined by a vector 116. In case the circular compliance direction 100b is selected, the user 16 may also provide a direction selection input (not illustrated) to select the radius of the circle of the compliance direction 100b.

FIG. 8e schematically represents the programming device 38 when a further example of a dialog box 110e is shown on the display 108. In response to the dialog box 110e, the user 16 may provide an impedance selection input 118 as a selection of a mechanical impedance with which the base 18 should exhibit the compliant behavior. A low mechanical impedance provides a large compliance of the base 18, and vice versa. Alternatively, the mechanical impedance may be automatically selected by the control system 30.

FIG. 8f schematically represents the programming device 38 when a further example of a dialog box 110f is shown on the display 108. In response to the dialog box 110f, the user 16 may provide a first control type input 120a to select a position control 122 of the drive wheels 22a and a second control type input 120b to select a velocity control 124 of the drive wheels 22a.

One, several or all of the coordinate system selection inputs 112a and 112b, the direction selection inputs 114a-114f, the impedance selection input 118, and the control type inputs 120a and 120b may be communicated from the programming device 38 to the control system 30. Prior to providing any of these inputs, the user 16 may for example consider environment space constraints, persons' movement patterns and/or a simulation of the environment of the AGV 12a, such as in RobotStudio ®, in order to select an appropriate compliance direction 100 and/or properties of the compliant behavior of the base 18. Alternatively, the control system 30 may automatically select an appropriate compliance direction 100 and properties of the compliant behavior of the base 18. In any case, after selection of the compliance direction 100, the AGV control program is provided in the control system 30, e.g., by the computer program therein, based on the selected compliance direction 100 and properties associated therewith. The AGV control program may comprise movement instructions for moving the AGV 12a from a start position 102 to a target position 104, positioning the AGV 12a at standstill in the target position 104 and then controlling the drive wheels 22a such that the heading directions 98 become aligned with the compliance direction 100 while the AGV 12a is at standstill in the target position 104. The user 16 can later change the compliance direction 100 and/or properties of the compliant behavior of the base 18 via the programming device 38.

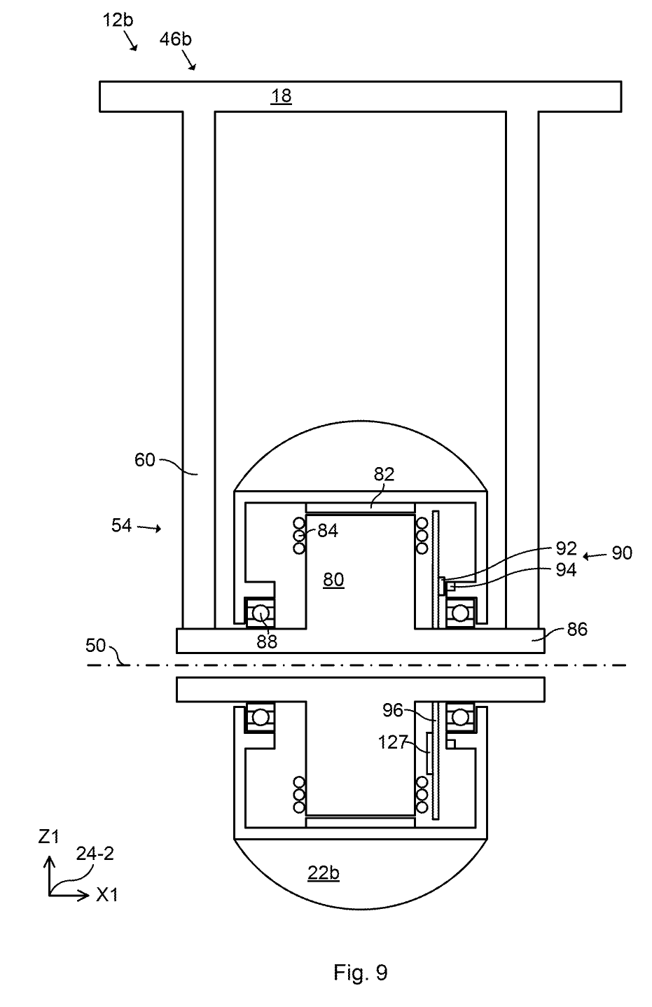

FIG. 9 schematically represents a cross-sectional side view of a further example of a drive unit 46b. Mainly differences between the drive unit 46b and the drive unit 46a will be described. Instead of the drive wheel 22a, the drive unit 46b comprises a drive wheel 22b. The drive unit 46b does not comprise a steering motor 56. Instead, the arm parts 60 are fixed to the base 18. The drive wheel 22b is thus only rotatable around the drive axis 50 and not around a steering axis 52.

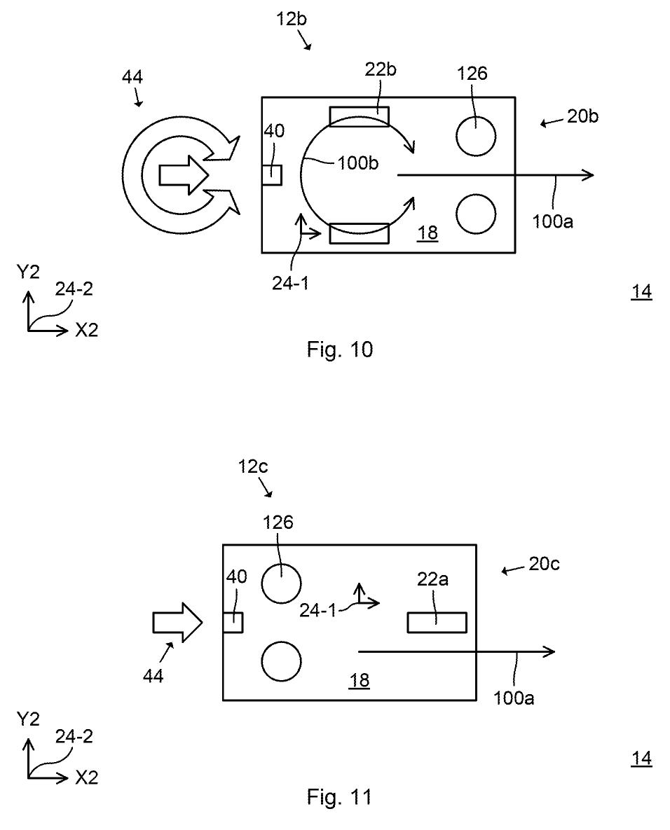

FIG. 10 schematically represents a top view of an AGV 12b according to a further example. Mainly differences between the AGV 12a and the AGV 12b will be described. The AGV 12b comprises a traction arrangement 20b. The traction arrangement 20b comprises two drive units 46b. The traction arrangement 20b of this example is thus a differential drive. The traction arrangement 20b of this example further comprises two swivel casters 126.

In FIG. 10, each drive wheel 22b is position controlled around its respective drive axis 50. The base 18 thereby exhibits a compliant behavior in both a linear compliance direction 100a and in a circular compliance direction 100b. A corresponding visual indication 44 is provided on the ground surface 14 by the projector 40.

The manipulator 26 is omitted from the illustration in FIG. 10. However, due to the ability of the first link 28 to rotate relative to the base 18, the AGV 12b can perform an omnidirectional motion of the first link 28 relative to the ground surface 14.

FIG. 11 schematically represents a top view of an AGV 12c according to a further example. Mainly differences between the AGV 12c and the AGV 12a will be described. The AGV 12c comprises a traction arrangement 20c. The traction arrangement 20c of this example comprises a single drive wheel 22a and two swivel casters 126. The base 18 is thus compliant in the heading direction 98 of the drive wheel 22a. A corresponding visual indication 44 is provided on the ground surface 14 by the projector 40.

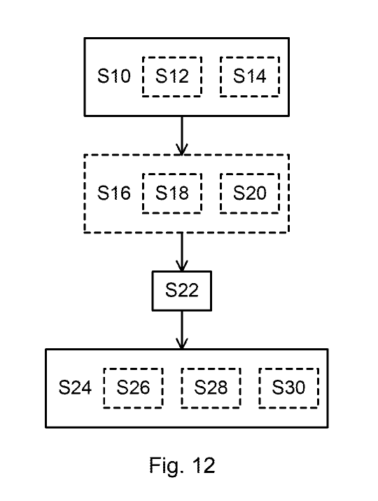

FIG. 12 is a flowchart outlining general steps of a method. The method comprises selecting S10 a compliance direction 100a and 100b in which the base 18 should exhibit a compliant behavior. The method further comprises providing S22, in the control system 30 and based on the selected compliance direction 100a and 100b, the AGV control program, the AGV control program comprising program code which, when executed by the control system 30, causes the control system 30 to control the AGV 12a-12c to be positioned at standstill such that the heading direction 98 of each drive wheel 22a and 22b is aligned with the compliance direction 100a and 100b and such that the base 18 exhibits the compliant behavior in the compliance direction 100a and 100b. The method further comprises executing S24, by the control system 30, the AGV control program.

The selection S10 of the compliance direction 100a and 100b may comprise receiving S12, by the programming device 38, the direction selection input 114a-114f from the user 16. Alternatively, the selection of the compliance direction 100a and 100b may comprise automatically selecting S14, by the control system 30, the compliance direction 100a and 100b.

The method may further comprise selecting S16 the mechanical impedance with which the base 18 should exhibit the compliant behavior, wherein the provision S22 of the AGV control program is made based on the selected mechanical impedance. The selection S16 of the mechanical impedance may comprise receiving S18, by the programming device 38, the impedance selection input 118 from the user 16. Alternatively, the selection S16 of the mechanical impedance may comprise automatically selecting S20, by the control system 30, the mechanical impedance.

The execution S24 of the AGV control program may further comprise providing S26, by the display device, the visual indication 44 indicative of the selected compliance direction 100a and 100b.

The execution S24 of the AGV control program may further comprise position controlling S28 or velocity controlling S30 each drive wheel 22a and 22b around a respective drive axis 50.

In the context of the present disclosure, the disclosed method provides a selected compliance behavior for the AGV. The selection may be made by a human user or automatically by the control system. In case the user pushes the base in the compliance direction, the AGV will immediately move in the compliance direction due to the compliant behavior exhibited by the base in the compliance direction. The method therefore enables the AGV to be more easily be moved aside manually by the user. Consequently, the method improves safety in an environment of the AGV.

The method also provides an advantage in that the base may exhibit a compliant behavior only in the compliance direction. In these cases, even if a human user does not push the base exactly along the compliance direction, the AGV will move along the compliance direction. Therefore, the AGV can be integrated better in complex environments, for example to avoid collision with any fragile obstacle when being pushed by the user.

Since the AGV comprises at least one drive wheel rotatable around a drive axis to generate a tractive force in the heading direction, the AGV is not compliant in directions transverse to the heading direction. The at least one drive wheel thus differs from, for example, a Swedish wheel. The compliance direction may be parallel with a plane comprising the drive axis and the heading direction of at least one drive wheel.

When the AGV is at standstill, the base is in a stationary position, e.g., at a fixed position in a global coordinate system. Components of the AGV other than the base may however move when the base is at standstill. The AGV control program may further comprise program code which, when executed by the control system, causes the control system to control the AGV to move from a start position to a target position, and then control the AGV to be positioned at standstill at the target position such that the heading direction of each drive wheel is aligned with the compliance direction and such that the base exhibits the compliant behavior in the compliance direction. When the AGV moves from the start position to the target position, the base moves from the start position to the target position. The target position may thus be horizontally distanced, e.g., at least 1 meter, from the start position in case the AGV travels on a horizontal ground surface.

The AGV may comprise a plurality of wheels. Each wheel may be in contact with a ground surface, such as a horizontal ground surface, such as a floor. The compliance direction may be parallel with this ground surface. One, several or all of these wheels may be drive wheels. One, several or none of these wheels may be non-driven wheels, such as swivel casters.

The AGV may be configured to perform an omnidirectional motion of the base, or of a body connected to the base, relative to the ground surface. The omnidirectional motion enables the base or the body to be moved with three degrees of freedom, namely in an arbitrary direction along the ground surface at the same time as the base rotates in an arbitrary direction around an axis transverse to the ground surface, such as a vertical axis. The base may for example be a platform.

The AGV may optionally comprise a manipulator. The manipulator may be a robot arm programmable in three or more axes, such as in six or seven axes. The manipulator may be supported on the base and movable relative to the base. The AGV may for example be an autonomous mobile robot, AMR, or an autonomous mobile manipulator robot, AMMR, comprising the manipulator. When the AGV comprising the manipulator is at standstill, the base is in a stationary position, but the manipulator may move relative to the base.

The AGV may for example comprise at least one steerable drive wheel, i.e., also rotatable relative to the base around a steering axis transverse to each of the drive axis and the heading direction, e.g. around a vertical steering axis. For any position adopted by the base, each steerable drive wheel can be positioned arbitrarily around its steering axis. This may be referred to as a redundancy of the AGV. The method of the first aspect may utilize this redundancy by positioning each steerable drive wheel around its steering axis such that the heading direction of each steerable drive wheel is aligned with the compliance direction and such that the base exhibits the compliant behavior in the compliance direction.

As a further example, the AGV may comprise a differential drive comprising two drive wheels that are not rotatable relative to the base around a steering axis. In this case, the AGV may comprise a body connected to the base and arranged to rotate relative to the base around a vertical axis. Such body may for example be a first link of a manipulator. For any position adopted by the body, the base and the drive wheels may be oriented arbitrarily in one or more planes parallel with the ground surface. This is a further example of a redundancy of the AGV. The method of the first aspect may utilize also this redundancy by driving the drive wheels to position the base such that the heading direction of each drive wheel is aligned with the compliance direction and such that the base exhibits the compliant behavior in the compliance direction.

The compliance direction may be selected either in a global coordinate system, in which the AGV is configured to move, or in a local coordinate system fixed to the base.

The selection of the compliance direction may comprise receiving, by a programming device, a direction selection input from a user. The compliance direction may thus be set during programming of the AGV, such as when programming the AGV to perform a task in a workplace. The direction selection input may be communicated electrically from the programming device to the control system, e.g., wirelessly or via a signal cable.

Alternatively, the control system may be configured to select the compliance direction or suggest a selection to the user, for example based on a map of an environment where the AGV will perform a task. For example, in case there is a free space available next to the AGV, the control system may be configured to select the compliance direction to be towards this free space, or suggest a corresponding selection to the user, e.g., via the programming device.

The direction selection input may comprise a selection indicative of a linear compliance direction and/or a rotational compliance direction. In case the compliance direction is a linear compliance direction, each heading direction may be parallel with the compliance direction. In case the compliance direction is a rotational compliance direction, the compliance direction may be defined by a circle. In the latter case, each heading direction may be oriented transverse to a line between a center of the circle and the respective drive wheel in order to align each heading direction with the compliance direction. In case the AGV comprises a plurality of steerable drive wheels, each drive wheel may be oriented such that an instantaneous center of rotation, ICR, is coinciding with the center of the circle.

The direction selection input may comprise a selection indicative of a position and/or an orientation of the compliance direction in a local coordinate system of the AGV or in a global coordinate system of the AGV.

The method may further comprise selecting a mechanical impedance with which the base should exhibit the compliant behavior. In these cases, the provision of the AGV control program may be made based on the selected mechanical impedance. For a relatively low mechanical impedance, the behavior of the base is more compliant than for a second relatively high mechanical impedance, higher than the relatively low mechanical impedance. The mechanical impedance is thus a measure of how much the base resists a force in the compliance direction.

The selection of the mechanical impedance may comprise receiving, by a programming device, an impedance selection input from a user. The impedance selection input may be communicated electrically from the programming device to the control system, e.g., wirelessly or via a signal cable.

The method may further comprise providing, by a display device, a visual indication indicative of the selected compliance direction. By virtue of the visual indication, users are notified of in which direction the base exhibits the compliant behavior. Thus, user experience is improved. The interaction between the user and the AGV is also improved, and users will tend to more often try to physically move the base in the compliance direction. This contributes to an improved safety in an environment of the AGV.

Moreover, in some implementations, the AGV may comprise a skirt covering the drive wheels, e.g., for safety reasons or aesthetic reasons. In such cases, the user may not see how each drive wheel is oriented and the use of the visual indication is particularly advantageous. However, in some other implementations, one or more drive wheels may be visible for the user who may thereby understand the orientation of the compliance direction. Furthermore, it may sometimes be apparent from the surrounding environment how the compliance direction has been selected.

The display device may be comprised by the AGV. The display device may for example be connected to the base or to a manipulator thereof. Alternatively, the display device may be fixed in a global coordinate system in which the AGV moves, e.g., connected to a stationary structure.

The display device may be a projector. In these cases, the provision of the visual indication may comprise projecting, by the projector, a light beam to provide the visual indication. The light beam may for example be projected on the ground surface or on the base. As an alternative, the display device may comprise a display screen configured to provide the visual indication.

The method may further comprise position controlling or velocity controlling each drive wheel around a respective drive axis. In both these ways, the base exhibits the compliant behavior in the compliance direction.

According to a second aspect, there is provided an automated guided vehicle, AGV, the AGV comprising a base; at least one drive wheel connected to the base, each drive wheel being rotatable relative to the base around a drive axis to generate a tractive force in a heading direction transverse to the drive axis; and a control system configured to control the AGV, the control system comprising at least one data processing device and at least one memory having at least one computer program stored therein, the at least one computer program comprising program code which, when executed by the at least one data processing device, causes the at least one data processing device to select or receive a selection of a compliance direction in which the base should exhibit a compliant behavior; and provide, based on the selected compliance direction, an AGV control program, the AGV control program comprising program code which, when executed by the at least one data processing device, causes the at least one data processing device to control the AGV to be positioned at standstill such that the heading direction of each drive wheel is aligned with the compliance direction and such that the base exhibits the compliant behavior in the compliance direction. The AGV according to the second aspect may be of any type mentioned in connection with the first aspect, and vice versa.

The AGV may further comprise a manipulator programmable in three or more axes and supported on the base.

According to a third aspect, there is provided a system comprising the AGV according to the second aspect and a programming device configured to be in signal communication with the control system and configured to receive a direction selection input from a user indicative of the compliance direction. The signal communication may be wireless or via a signal cable. The programming device may for example be a teach pendant unit, TPU. The programming device according to the third aspect may be of any type mentioned in connection with any of the first and second aspects, and vice versa.

According to a fourth aspect, there is provided a system comprising the AGV according to the second aspect and a display device configured to provide a visual indication indicative of the selected compliance direction. The display device according to the third aspect may be of any type mentioned in connection with any of the first to third aspects, and vice versa.

The display device may be a projector configured to project a light beam to provide the visual indication.

The system according to the third and fourth aspects may be the same system. Each of the systems according to the third and fourth aspects may be referred to as an automated guided vehicle, AGV, system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of controlling an automated guided vehicle (AGV), the AGV comprising:
a base;
at least one drive wheel connected to the base, the at least one drive wheel being rotatable relative to the base around a drive axis to generate a tractive force in a heading direction transverse to the drive axis; and
a control system configured to control the AGV;
wherein the method comprises:
selecting a compliance direction in which the base should exhibit a compliant behavior;
providing, in the control system and based on the selected compliance direction, an AGV control program, the AGV control program comprising program code which, when executed by the control system, causes the control system to control the AGV to be positioned at standstill such that the heading direction of each drive wheel is aligned with the compliance direction and such that the base exhibits the compliant behavior in the compliance direction; and
executing, by the control system, the AGV control program.

2. The method according to claim 1, wherein the selection of the compliance direction comprises receiving, by a programming device, a direction selection input from a user.

3. The method according to claim 2, wherein the direction selection input comprises a selection indicative of a linear compliance direction and/or a rotational compliance direction.

4. The method according to claim 3, wherein the direction selection input comprises a selection indicative of a position and/or an orientation of the compliance direction in a local coordinate system of the AGV or in a global coordinate system of the AGV.

5. The method according to claim 1, further comprising selecting a mechanical impedance with which the base should exhibit the compliant behavior, wherein the provision of the AGV control program is made based on the selected mechanical impedance.

6. The method according to claim 5, wherein the selection of the mechanical impedance comprises receiving, by a programming device, an impedance selection input from a user.

7. The method according to claim 1, further comprising providing, by a display device, a visual indication indicative of the selected compliance direction.

8. The method according to claim 7, wherein the display device is a projector, and wherein the provision of the visual indication comprises projecting, by the projector, a light beam to provide the visual indication.

9. The method according to claim 1, further comprising position controlling or velocity controlling the at least one drive wheel around a respective drive axis.

10. An automated guided vehicle (AGV), the AGV comprising:
a base;
at least one drive wheel connected to the base, the at least one drive wheel being rotatable relative to the base around a drive axis to generate a tractive force in a heading direction transverse to the drive axis; and
a control system configured to control the AGV, the control system comprising at least one data processing device and at least one memory having at least one computer program stored therein, the at least one computer program comprising program code which, when executed by the at least one data processing device, causes the at least one data processing device to:
select or receive a selection of a compliance direction in which the base should exhibit a compliant behavior; and
provide, based on the selected compliance direction, an AGV control program, the AGV control program comprising program code which, when executed by the at least one data processing device, causes the at least one data processing device to control the AGV to be positioned at standstill such that the heading direction of at least one drive wheel is aligned with the compliance direction and such that the base exhibits the compliant behavior in the compliance direction.

11. The AGV according to claim 10, further comprising a manipulator programmable in three or more axes and supported on the base.

12. The AGV according to claim 10, further comprising a programming device configured to be in signal communication with the control system and configured to receive a direction selection input from a user indicative of the compliance direction.

13. The AGV according to claim 10, further comprising a display device associated with the AGTV, the display device configured to provide a visual indication indicative of the selected compliance direction.

14. The AGV according to claim 13, wherein the display device is a projector configured to project a light beam to provide the visual indication.
